(19) United States
(12) Patent Application Publication
(10) Pub. No.: US 2025/0343806 A1
(43) Pub. Date: Nov. 6, 2025

(54) METHOD FOR DETECTING THREATS IN COMMUNICATIONS AND SYSTEM THEREFOR

(71) Applicant: FireDome Ltd., Herzliya (IL)

(72) Inventors: Orr CHEN, Tel Aviv (IL); Moti SHKOLNIK, Rishpon (IL); Guy GOLDFARB, Hod Hasharon (IL); Netta Dafna SCHMEIDLER, Herzliya (IL); Aviv SINAI, Kadima-Zoran (IL)

(21) Appl. No.: 18/655,478

(22) Filed: May 6, 2024

Related U.S. Application Data
(63) Continuation-in-part of application No. 18/655,438, filed on May 6, 2024.

(51) Int. Cl. H04L 9/40; H04L 61/5014

(52) U.S. Cl. CPC H04L 63/1416; H04L 61/5014

(57) ABSTRACT

A computer-implemented method for detecting a threat in a communication sent from an initiating network entity to a destination network entity is included. The method includes, by a processor of a router, receiving, the communication, wherein the communication is directed from an initiating address of an initiating network entity to a destination address of a destination network entity, in accordance with a predefined rule associated with at least one of the initiating address or the destination address, rerouting the communication to a designated appliance (DEAP), to enable monitoring of the communication to detect threats, wherein the predefined rule is indicative of a required security monitoring of communications involving at least one of the initiating network entity or the destination network entity, and in case no indication of a threat is identified, routing the communication to the destination network entity

### TECHNICAL FIELD

The presently disclosed subject matter relates to cyber security, more particularly to detecting threats in communications exchanged between network entities, in particular between network entities in an organization.

### BACKGROUND

The landscape of network communication has rapidly evolved, becoming indispensable in the digital era, and underscoring the need for stringent security mechanisms. Traditional security measures are increasingly challenged by sophisticated cyber threats, revealing significant gaps in protection and response capabilities.

In the realm of Network Detection and Response (NDR), the focus is on enhancing the visibility of organizational networks to effectively detect and respond to potential threats. Presently, examination and management of network traffic predominantly rely on hardware-based solutions. Such solutions involve integrating hardware devices with essential network components such as routers and switches, enabling the monitoring of traffic. While employing Deep Packet Inspection (DPI), these devices meticulously analyse all data passing through the network to identify potential security threats. However, these hardware-based approaches demand significant resources and necessitate a tangible integration within the network's infrastructure. These approaches typically require the deployment of devices capable of capturing traffic copies, conducting packet sniffing, and duplicating traffic across network ports. These devices are expected to have substantial processing power to analyse data, either locally or by offloading it to cloud services.

Meanwhile, alternative software-based solutions offer a different approach, primarily through traffic sampling or focusing on metadata analysis. These methods, which involve monitoring select segments of network traffic, or examining data characteristics such as the metadata of the traffic without analysing the content, are considered to be inferior and less effective compared to DPI strategies.

Given the finite resources inherent in network environments, it is required to employ a security strategy that not only effectively counters the diverse array of threats facing organizational networks, but also optimizes the use of available resources.

Other known security solutions such as port mirroring (also known as SPAN (Switched Port Analyzer)) exist. Such solutions are often used on network switches to send a copy of network packets seen on one switch port (or an entire VLAN) to a network monitoring connection on another switch port for network security purposes. However, while port mirroring is valuable for passive monitoring and troubleshooting, by itself it is not sufficient for comprehensive security defence, as it only deals with copies, the original traffic continuing to flow through the network unchanged. This means that while port mirroring allows for extensive observation and data collection, it does not have the ability to alter, block, or manipulate the actual traffic in any way. Thus, organizations must integrate port mirroring with active security systems that can take immediate action based on the insights provided by the monitoring process, to ensure that any threats detected through port mirroring can be promptly and effectively mitigated, to obtain overall security strength of the network. It is therefore desired to obtain a different solution that mitigates these security and performance issues while still providing effective network traffic monitoring capabilities.

### General Description

Addressing the challenge of optimizing network resources, while ensuring robust security measures against an ever-evolving landscape of cyber threats, necessitates a revision of traditional security approaches. Both hardware-based and software-based solutions have shown limitations, either by imposing resource demands on networks and costs pertaining to initial setup and maintenance of the infrastructure, or by offering incomplete threat detection coverage. Hence, there is a compelling need for a solution that enhances a balance between efficiency and comprehensive security.

According to certain embodiments of the presently disclosed subject matter, there is a provided method for detecting a threat in traffic exchanged between network entities. A threat can be regarded to include any potential threat or monitoring of information that requires a certain action from the network or a network administrator. When network entities are defined as protected entities, in order to detect threats in communication originated by the entities or directed towards them as destinations the protected entities are isolated from communicating with entities in the network, and all communication is routed to a router to transmit the communication to a designated appliance, such as trusted zone, for enabling to monitor threats and optionally collect data for enrichment purposes and improvement of the system, allowing to improve accuracy. If no threats are identified, then the communication returns back to its original route and reaches the destination. If threats are identified, the actions can be taken, either by the router, or by the designated appliance, such as blocking the communication, applying rules on the protected entities, etc. Using configuration update of Internet protocol (IP) addresses of protected entities as well as associating rules with the updated IP addresses, such that the traffic involving protected entities, on its path from the source to the destination, is rerouted to pass through a designated appliance (referred to also as ‘DEAP’). This enables the isolation of the protected entities from communicating with other entities in the network, and the monitoring of the desired communication. The DEAP, may be a computerized entity, either virtual or physical, having processing, memory, communicating and routing capabilities.

The DEAP may communicate with the routing entity and is specifically configured to enable the monitoring of traffic to detect threats. In certain examples, monitoring occurs directly at the DEAP, while in other cases, traffic or data indicative of the traffic may be forwarded to a different appliance or service, either within the network or externally in the cloud, for threat inspection. The process of rerouting communications involves dynamically adjusting the routes that network traffic takes through the network infrastructure. By rerouting the communication to the DEAP, the system can monitor the communication in real-time or near real-time, detect threats promptly, and take immediate action on the communication itself if a threat is identified. This capability significantly enhances the security of communications within the network. On the other hand, in case no threat is detected, the communication reverts back to its original route, thereby reaching the destination in a transparent manner to the involved entities, while complying with all network rules, restrictions and procedures.

Inspection can be conducted using known methods through one or more of the hardware-based or software-based techniques previously described. If no threat is detected, the DEAP is configured to forward the traffic to its intended destination, optionally, through the router that rerouted the communication to the DEAP, thereby guaranteeing the secure and transparent delivery of traffic within the network, without the entities involved being aware of the intervention. Conversely, if a potential threat is detected, the DEAP is prepared in advance, to enable taking immediate action. For instance, it can instantly block the traffic from being transmitted to the router and/or from reaching its intended destination, effectively preventing the potential threat from propagating, quarantine the communication/one or the involved entities or can determine rules applying on future or conditional communications pertaining to the original and/or the destination network entity.

Rerouting traffic through a designated appliance, which enables traffic monitoring, offers multiple advantages. This approach focuses on precision-targeted monitoring of network traffic, aiming to significantly reduce the resource intensity that is typically associated with comprehensive security measures like Deep Packet Inspection (DPI). The DEAP is specifically configured to facilitate in-depth analysis of rerouted communications, effectively identifying potential threats with enhanced efficiency and accuracy, without necessitating full integration of hardware devices with critical network components, such as routers and switches. Additionally, upon detecting a threat during traffic inspection, the system is capable of taking immediate action to mitigate or halt the threat. This method of rerouting traffic directly through DEAP allows actions to be taken on the actual traffic, rather than just inspecting a copy, as is common in traditional solutions. Therefore, the use of a DEAP not only focuses on pre-emptive threat identification and rapid response capabilities, but also provides a robust defence mechanism that boosts overall network security, whilst balancing with diminished performance or increasing operational costs. Moreover, the approach described herein introduces a level of resource efficiency that was previously unattainable with conventional security solutions, allowing organizations to better utilize their network infrastructures. The solution is also flexible and scalable, enhancing network effectiveness. While the proposed method may introduce some delays in communication rates, these can potentially be minimized or avoided by deploying multiple designated appliances, DEAPs, across different areas of an organization's network, such as one per floor, depending on the network's size or other factors influencing traffic delays, thus maintaining a balance between network resources, efficiency, and comprehensive security.

The claimed subject matter provides a nuanced approach to network security compared to traditional firewall solutions, which primarily focus on monitoring and controlling incoming and outgoing traffic at the perimeter of an organization's network. Firewalls act as a barrier between a trusted internal network and an untrusted external network, filtering traffic based on predetermined security rules without distinguishing between the source and destination entities within the internal network itself. This often means that internal communications, which can also pose security risks, may not be adequately monitored by firewalls. In contrast, the claimed subject matter aims to provide a solution designed to monitor also communications between designated network entities within the organization. It focuses on the interactions between these entities, irrespective of whether the traffic is internal or crossing the network boundary. As such, the proposed claimed subject matter allows for a more targeted approach, where traffic can be rerouted for detailed inspection and potential threat detection based on the source or destination entities, enhancing the ability to detect threats that might otherwise remain undetected by a standard firewall.

According to a first aspect of the presently disclosed subject matter there is provided a computer-implemented method for detecting a threat in a communication sent from an initiating network entity to a destination network entity, the method comprising:
by a processor of a router:
   receiving, the communication, wherein the communication is directed from an initiating address of an initiating network entity to a destination address of a destination network entity;
   in accordance with a predefined rule associated with at least one of the initiating address or the destination address, rerouting the communication to a designated appliance (DEAP), to enable monitoring of the communication to detect threats, wherein the predefined rule is indicative of a required security monitoring of communications involving at least one of the initiating network entity or the destination network entity; and
   in case no indication of a threat is identified, routing the communication to the destination network entity.

In addition to the above features, the computer implemented method according to this aspect of the presently disclosed subject matter can optionally comprise in some examples one or more of features (i) to (xii) below, in any technically possible combination or permutation:
(i). Wherein initiating network entity and the destination network entity belong to the same organization network.
(ii). Wherein the address of at least one of the initiating network entity or the destination network entity emerges from a configuration update at a Dynamic Host Configuration Protocol (DHCP) server, assigning a new address to the respective network entity, thereby facilitating the rerouting of communications involving the respective network entity based on the associated predefined rule.
(iii). Wherein the address from the configuration update is allocated in a designated segment of addresses, wherein addresses in the designated segment are isolated such that communications directed to or from addresses in the designated segment are associated with one or more predefined rules pertaining to rerouting of communications to at least one DEAP.
(iv). The method further comprising, by a processor of the DEAP:
   monitoring the communication to detect threats.
(v). The method further comprising, by the processor of the DEAP:
   transmitting data indicative of the communication to a different appliance to monitor.
(vi). The method further comprising, by the processor of the DEAP:
   enabling selective monitoring of the communication to detect threats.
(vii). The method further comprising:
   receiving an indication of a potential threat.
(viii). The method further comprising:
   taking at least one action.
(ix). Wherein the at least one action can be applied on the initiating and destination network entities and/or on communications flow between the network entities and can be selected from a group comprising: blocking transmission of future communications, conditional blocking one or more of the network entities from engaging in further communications, enforcing pre-configured rules that involve timing restrictions on communications applying, or a combination thereof.
(x). Wherein the at least one action is applied on the communications themselves.
(xi). The method further comprising, prior to routing the communication:
   receiving the communication back from the DEAP.
(xii). Wherein the DEAP is either the initiating network entity or the destination network entity, and wherein the predefined rule involves monitoring communications to or from the DEAP to detect threats.

The presently disclosed subject matter further comprises a computer system comprising a processing circuitry that comprises at least one processor and a computer memory, the processing circuitry being configured to execute a method as described above with reference to the first aspect, and may optionally further comprise one or more of the features (i) to (xii) listed above, mutatis mutandis, in any technically possible combination or permutation.

The presently disclosed subject matter further comprises a non-transitory computer readable storage medium tangibly embodying a program of instructions that, when executed by a computer, cause the computer to perform a method as described above with reference the first aspect, and may optionally further comprise one or more of the features (i) to (xii) listed above, mutatis mutandis, in any technically possible combination or permutation.

According to a second aspect of the presently disclosed subject matter there is provided a system comprising a plurality of network entities configured to exchange communications with each other, wherein the method as described above, with reference to the first aspect, is selectively implemented on at least one of the communications.

In addition to the above features, the system according to the second aspect of the presently disclosed subject matter can comprise one or more of features (i) to (iii) listed below, in any desired combination or permutation which is technically possible:
(i). Wherein the method is selectively implemented on communications exchanged between a subgroup of the network entities.
(ii). Wherein each address of each network entity in the subgroup emerges from a configuration update at a Dynamic Host Configuration Protocol (DHCP) server, assigning a new address to the respective network entity, thereby facilitating rerouting of communications involving the respective network to the DEAP, based on the associated predefined rule.
(iii). Wherein the addresses from the configuration update are allocated in at least one designated segment of addresses, and are isolated such that communications directed to or from addresses in the designated segment are associated with one or more predefined rules, pertaining to rerouting of communications to at least one DEAP.

The presently disclosed subject matter further comprises computer system for detecting a threat in a communication sent from an initiating network entity to a destination network entity, the system comprising a processing circuitry comprising at least one processor and computer memory, the processing circuitry being configured to execute a method as described above with reference to the first aspect and may optionally further comprise one or more of the features (i) to (xii) listed above, mutatis mutandis, in any technically possible combination or permutation.

The presently disclosed subject matter further comprises a non-transitory computer readable storage medium tangibly embodying a program of instructions that, when executed by a computer, cause the computer to perform a method for detecting a threat in a communication sent from an initiating network entity to a destination network entity as defined as described above with reference the first aspect, and may optionally further comprise one or more of the features (i) to (xii) listed above, mutatis mutandis, in any technically possible combination or permutation.

According to a third aspect of the presently disclosed subject matter there is provided a computer-implemented system for detecting a threat in a communication exchanged between network entities, the system comprising:
a router configured to:
   receiving, the communication, wherein the communication is directed from an initiating address of an initiating network entity to a destination address of a destination network entity; and
   in accordance with a predefined rule associated with at least one of the initiating address or the destination address, rerouting the communication to a designated appliance (DEAP), wherein the predefined rule is indicative of a required security monitoring of communications involving at least one of the initiating network entity or the destination network entity;
the DEAP, in communication with the router, is configured to:
   receive the communication from the router;
   enable monitoring of the of the communication to detect threats and communicate a suitable indication to the router; and
wherein in case no indication of a threat is identified, the router is further configured to:
   routing the communication to the destination network entity.

In addition to the above features, the system according to the third aspect of the presently disclosed subject matter can comprise the following features (i) to (v) in any technically possible combination or permutation:
(i). The system further comprising:
   a Dynamic Host Configuration Protocol (DHCP) server configured for implementing a configuration update process that assigns new address to network entities to facilitate rerouting of communications involving the respective network entities based on associated predefined rules.
(ii). Wherein the DEAP is further configured to:
   monitor the communication to detect threats.
(iii). Wherein the DEAP is further configured to:
   transmit the communication to a different appliance to monitor to detect threats.
(iv). Wherein the DEAP is further configured to:
   enable selective monitoring of the communication to detect threats.
(v). Wherein in case of an indication of a potential threat, the DEAP is further configured to:
   take at least one action.

According to a fourth aspect of the presently disclosed subject matter there is provided a computer-implemented method for facilitating detection of threats in a network, comprising:
selecting at least one group of network entities, based on a respective calculated risk score of the one or more network entities;
for network entities within the selected group, determining at least one respective type of traffic data collection method appropriate for traffic exchanged with these network entities, thereby facilitating the application of one or more security techniques to detect threats using data collected according to the respective type; and
applying at least one security method based on the determined type by executing operations by a processor of a router on communication sent from an initiating network entity to a destination network entity, wherein at least one of the initiating network entity and the destination network entity are comprised within the selected group:
   receiving, the communication, wherein the communication is directed from an initiating address of an initiating network entity to a destination address of a destination network entity;
   in accordance with a predefined rule associated with at least one of the initiating address or the destination address, rerouting the communication to a designated appliance (DEAP), to enable monitoring of the communication to detect threats, wherein the predefined rule is indicative of a required security monitoring of communications involving at least one of the initiating network entity or the destination network entity; and
in case no indication of a threat is identified, routing the communication to the destination network entity.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1 illustrates a generalized network environment 100 including a system for detecting a threat in a communication, in accordance with certain embodiments of the presently disclosed subject matter;

FIG. 2 illustrates a functional block diagram of detection system 200, in accordance with certain embodiments of the presently disclosed subject matter;

FIG. 3 illustrates a generalized flowchart of operations performed by the detection system 200, in accordance with certain embodiments of the presently disclosed subject matter;

FIG. 4 illustrates a generalized flowchart of operations performed by the detection system 200, in accordance with certain embodiments of the presently disclosed subject matter;

FIG. 5 illustrates a high-level functional block diagram of a monitoring system 120, in accordance with certain embodiments of the presently disclosed subject matter; and

FIG. 6 illustrates a generalized flowchart of operations performed by the monitoring system 120, in accordance with certain embodiments of the presently disclosed subject matter.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components, and circuits have not been described in detail so as not to obscure the presently disclosed subject matter.

Unless specifically stated otherwise, as apparent from the following discussions, it is appreciated that throughout the specification discussions utilizing terms such as “receiving”, “rerouting”, “enabling”, “monitoring”, “routing”, “configuring”, “assigning”, “taking”, “transmitting”, or the like, refer to the action(s) and/or process(es) of a computer that manipulates and/or transform data into other data, said data represented as physical, such as electronic, quantities and/or said data representing the physical objects.

The term “computer”, “computer system”, “computer device”, “computerized device”, “computerized method” or the like, should be expansively construed to cover any kind of hardware-based electronic device with one or more data processing circuitries. A processing circuitry can comprise, for example, one or more processors operatively connected to computer memory of any suitable sort, loaded with executable instructions for executing operations, as further described below. The one or more processors referred to herein can represent, for example, one or more general-purpose processing devices such as a microprocessor, a central processing unit, or the like. More particularly, a given processor may be one of: a complex instruction set computing (CISC) microprocessor, a reduced instruction set computing (RISC) microprocessor, a very long instruction word (VLIW) microprocessor, a processor implementing other instruction sets, or a processor implementing a combination of instruction sets. The one or more processors may also be one or more special-purpose processing devices such as an application specific integrated circuit (ASIC), a field programmable gate array (FPGA), a digital signal processor (DSP), a graphics processing unit (GPU), a network processor, or the like. By way of non-limiting example, computerized systems or devices can include detection system 200, disclosed in the present application.

The operations in accordance with the teachings herein may be performed by a computer specially constructed for the desired purposes or by a general-purpose computer specially configured for the desired purpose by a computer program stored in a non-transitory computer-readable storage medium.

Embodiments of the presently disclosed subject matter are not described with reference to any particular programming language. It will be appreciated that a variety of programming languages may be used to implement the teachings of the presently disclosed subject matter as described herein.

As used herein, phrases including “for example”, “such as”, “for instance” and variants thereof, describe non-limiting embodiments of the presently disclosed subject matter. Usage of conditional language, such as “may”, “might”, or variants thereof, should be construed as conveying that one or more examples of the subject matter may include, while one or more other examples of the subject matter may not necessarily include, certain methods, procedures, components, and features. Thus, such conditional language is not generally intended to imply that a particular described method, procedure, component, or circuit is necessarily included in all examples of the subject matter. Moreover, the usage of non-conditional language does not necessarily imply that a particular described method, procedure, component, or circuit is necessarily included in all examples of the subject matter. Also, reference in the specification to “one case”, “some cases”, “other cases”, or variants thereof, means that a particular feature, structure, or characteristic described in connection with the embodiment(s) is included in at least one embodiment of the presently disclosed subject matter. Thus, the appearance of the phrase “one case”, “some cases”, “other cases”, or variants thereof does not necessarily refer to the same embodiment(s).

It is appreciated that certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

Likewise, various elements described as distributed over different computers can be otherwise consolidated into a single computer device. For example, the functionalities of router 104 and designated appliance (referred to herein and below also as ‘DEAP’) 102 can be consolidated and implemented in a single computer network entity. In some examples, the detection system 200 is implemented on a single computer.

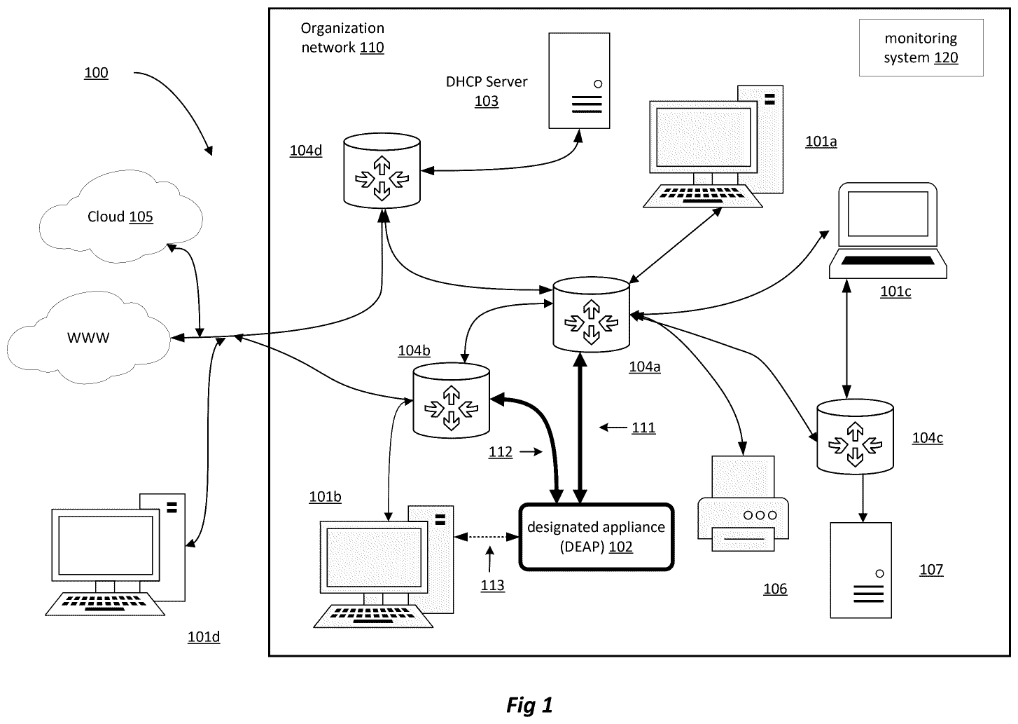

Bearing this in mind, attention is drawn to FIG. 1 illustrating a generalized network environment 100 and an organization network 110 operating a system for detecting a threat in a communication, in accordance with certain embodiments of the presently disclosed subject matter. The environment 100 is configured to enable execution of a computer-implemented method for detecting a threat in a communication sent from an initiating network entity to a destination network entity, where communication can be regarded as any network traffic including e.g. data packets transmitted in the network.

The environment 100 may include several entities, all operatively communicating with each other via a network. The environment 100 may include organization network 110 (referred to also as ‘network 110’), and other entities which reside outside the network 110. The network 110 may also include a plurality of network entities, operatively connected to each other, and communicate through a network infrastructure that is owned or operated by an organization or a group of linked organizations. The network entities within the environment 100 may comprise various computerized devices. For example, computers 101a-101c including desktop computers 101a, 101b, or laptops such as 101c. The network entities comprised in network 110 may also comprise one or more printers 106, one or more servers 107, storage entities, containers, virtual machines (not shown), IoT devices, cameras, IP phones, and any other network entity configured for communicating in the network 110. The network 110 can also include one or more routers 104, such as 104a and 104b, one or more designated appliances (DEAPs) 102, and a Dynamic Host Configuration Protocol (DHCP) server 103. The environment 100 may comprise also network entities residing outside the network 110 configured for communicating with network entities within the network 110, such as the computer 101d and services in the cloud 105.

In some cases, the entities in network 110 and outside it are configured to communicate with each other by initiating and receiving communications exchanged between the entities. The routers 104a-104b can include any routing entity, including computerized devices with routing capabilities, such as a Firewall, and are configured to route the communications exchanged between the entities in network 110. The DHCP server 103 is configured to assign IP addresses to network entities within the network 110 so they can communicate with other network entities inside and outside the network 110.

The DEAP 102 can be a trusted platform or entity, either virtual or physical, optionally, implemented as an edge component. The DEAP 102 may also have a cloud component. The DEAP 102 may have processing, memory, communicating and routing capabilities. The DEAP 102 may form part of the organization network 110 that is designed as a secure area. The DEAP 102 may communicate with one or more routers 104, optionally, through tunnels established between particular routers and the DEAP 102. The DEAP 102 may collect data and may send it to security systems outside the organization network 110 configured for monitoring threats. The DEAP 102 may also enforce cyber policies e.g., dictated by the backend (e.g. external systems) for a network entity or a group of entities and to block/accept/quarantine communications. The DEAP 102 may optionally run security logic on-premises including monitoring methods to detect threats, e.g. due to cost/privacy/offline capability/latency or other considerations.

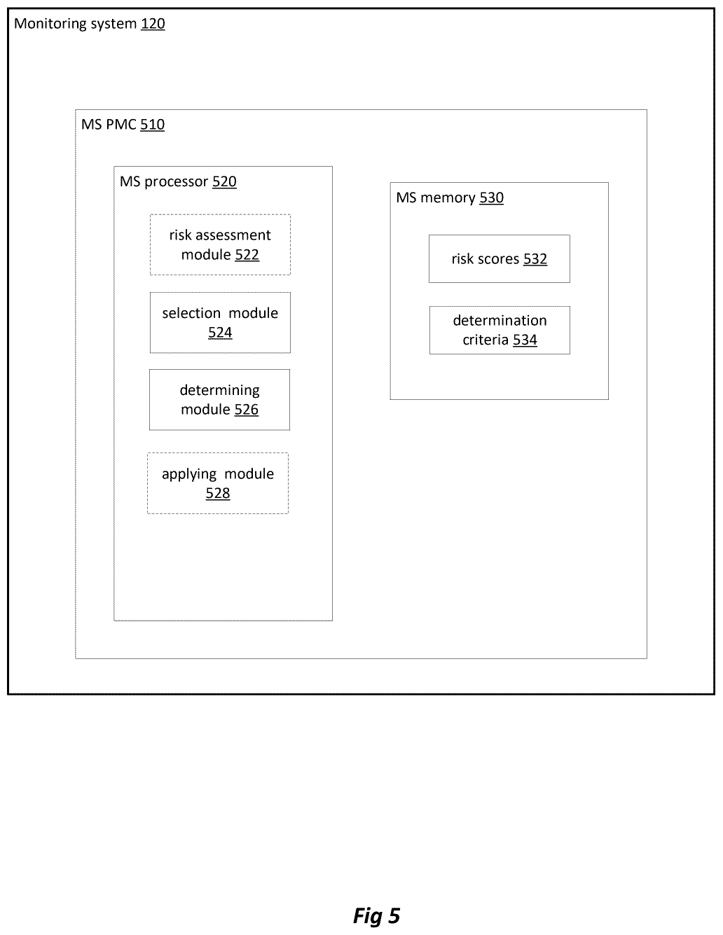

Assume that an organization operates network 110 and implements a method for detecting threats in communications exchanged between network entities according to the presently disclosed subject matter. The organization may select one or more network entities as protected entities for monitoring, such that communication involving the protected entities is routed to a router to transmit the communication to the DEAP 102, that enables to monitor threats. Such monitoring of communications can involve monitoring communications either initiated by or received by these protected network entities. Alternatively, the organization may decide to monitor all traffic from every network entity within the network 110. Further details of optional selection of the protected network entities are described with reference to FIG. 5.

To facilitate the monitoring of communications through rerouting to the DEAP, a configuration update process is executed at the DHCP server 103. During this process, the protected network entities are assigned with new IP addresses, distinct from their original IP addresses. Optionally, the new IP addresses reside in designated segments that may be set aside for special use and are not typically employed by the organization for regular network operations.

Additionally, rules that are indicative of required security monitoring are defined and associated with the new IP addresses. A set of rules may be added to at least one router's configuration. These rules should make the router 104 follow a predefined policy of rerouting traffic to/from the DEAP 102, e.g. through a dedicated tunnel between the router 104 and the DEAP 102. As illustrated in FIG. 1, for example, tunnels, marked by bolded lines 111 and 112, are established between the router 104a and the DEAP 102 and between the router 104b and the DEAP 102, respectively. These rules may be stored in one or more routers 104, which are operatively connected to the selected entities.

When a communication is received at the router 104, if the IP address of a network entity involved in the communication (either as the initiator or the destination) matches an IP address associated with a rule, the router should reroute the communication to the DEAP 102, e.g. using the tunnel, instead of transmitting it to the original intended destination. This ensures that, according to the presently disclosed subject matter, communications involving the protected entities are appropriately rerouted through the DEAP 102. Also, by assigning new IP addresses, in designated segments outside of the original network range which are not typically employed by the organization for regular network operations, prevents neighboring entities such as entities belonging to the same network, from communicating directly with the protected entities. Isolation of the protected entities is therefore achieved as the network entity having the new IP address belongs to another network. As such, all traffic should flow through the routing entity, which applies a predefined rule and reroutes the communication through the DEAP 102.

The DEAP 102 is configured to monitor communications for the detection of threats. This monitoring can occur directly within DEAP 102 or externally by transmitting the communication to external devices or services in a cloud environment (cloud 105) that are also configured to monitor communications. If no threat is identified e.g. by the DEAP 102, or if no indication of a threat is received from the cloud monitoring services, the DEAP 102 is configured to return the communication to the router 104, e.g., through the tunnel, so the communication is continued to be transmitted towards its original intended destination. If threat is identified an action can be taken by the DEAP 102, e.g. by blocking the communication, to prevent it from reaching the final destination, thus providing immediate protection to the network entities.

Consider the example of network entity 101a, a computer type (also referred to as ‘computer 101a’), sending a printing task to network entity 106, a printer type (also referred to as ‘printer 106’). According to the presently disclosed subject matter, in some cases, if printer 106 has been selected as a protected entity, meaning that traffic either initiated by or received at printer 106 is subject to monitoring, then such traffic should first be rerouted to DEAP 102 to allow for the monitoring of the printing task. To facilitate this rerouting, the original or current IP address of printer 106 may be updated at the DHCP server 103 to a new address, with a corresponding new routing rule associated with this new address. This rule is predefined in one or more routers, such as router 104a, which is operatively connected to printer 106. During operation, when computer 101a initiates a printing task, it is initially routed to router 104a. Under normal circumstances, and as depicted in FIG. 1, the direct route for the printing task to reach printer 106 would involve the route connecting computer 101a, router 104a, and printer 106, all interconnected. For this purpose, it should be clarified that in cases where two network entities are within the same network, ‘routing’ according to the presently disclosed subject matter should also cover to include the option of ‘switching’.

This path is followed unless rerouting is required due to factors such as network delays or traffic congestion, which might necessitate taking an alternative route. However, with the new IP address assigned to printer 106 and the corresponding routing rule set in router 104a, once the printing task is received from computer 101a, router 104a, recognizes the new IP address and the associated predefined rule, and reroutes the printing task to DEAP 102, e.g. through the tunnel 111. The DEAP 102 is configured to enable monitoring of the printing task to detect any potential threats. If no indication of a threat is received at the DEAP 102, the printing task is returned back to the router 104a, e.g., through tunnel 111, and is then routed by outer 104a to printer 106, ensuring the secure and transparent delivery of the printing task within the network. This operation is seamless to both computer 101a and printer 106.

It should be noted that this environment 100 and organization network 110 may be designed to accommodate a flexible and scalable network architecture, potentially encompassing multiple computers 101, routers 104, and numerous designated appliances DEAP 102. Each DEAP 102 within the system may be specifically tasked with monitoring and managing traffic for a subset of computers 101 within the network 110, based on either the origin or destination of the traffic. Also, in some examples, the DEAP 102 may be enriched with routing capabilities, thus enabling the DEAP 102 to route the communication directly to the destination in case no threat is identified. Also, in some implementations, several routers 104 may have tunnels to the DEAP 102, whether each router 104 handles a subnet comprising one or more entities including protected entities. This distributed approach facilitates that the system operated in the environment 100 and the network 110 may adapt to varying network sizes and configurations, providing tailored security monitoring and threat detection capabilities across different segments of the network. The configuration and allocation of responsibilities among the DEAP 102 are customizable, allowing for optimization and balance between traffic delays and the number of required DEAP 102 in the network 110. Also, it is to be noted that for ease of explanation, the term ‘router 104’ shall be used to refer to one or more routers 104 along a communication path, and it is understood that the description is equally applicable to one or multiple routers 104 along the path. Also, the description throughout this document refers, for illustration only, to network entities in an organization network 110 which resides on the organization's premises, however, this disclosure should not be limiting, and those versed in the art would realize that it includes also cloud environments, where the organization network 110 is implemented, partially or entirely, in the cloud.

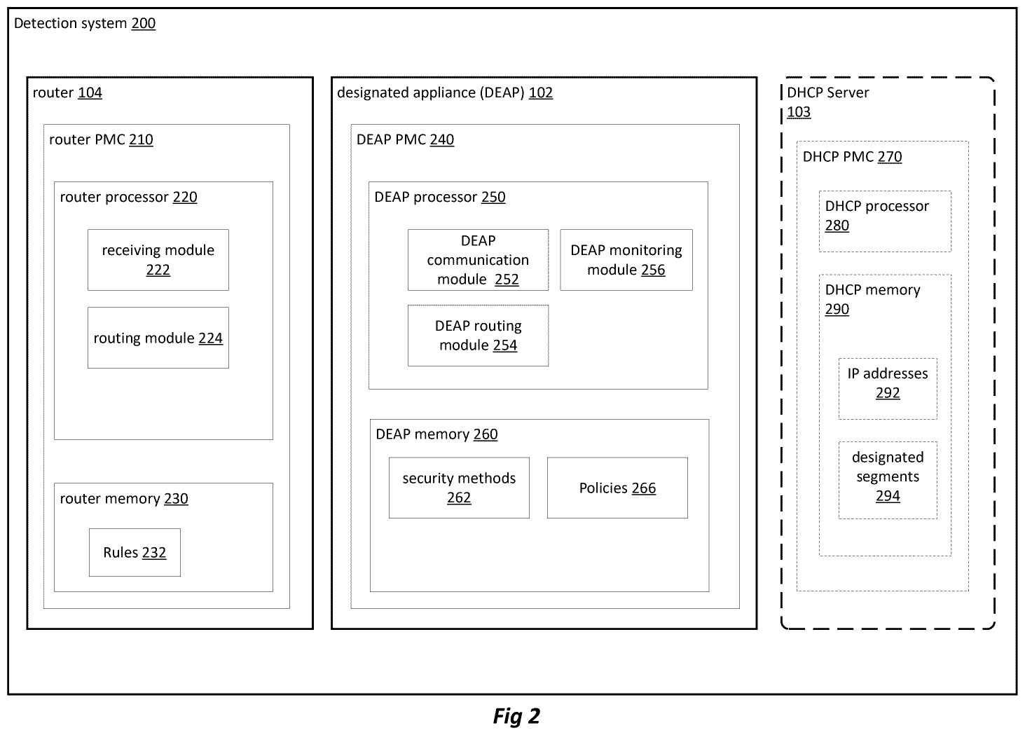

Attention is drawn to FIG. 2 illustrating a high-level functional block diagram of the detection system 200, in accordance with certain embodiments of the presently disclosed subject matter.

The system 200 may comprise the router 104 and the designated appliance (DEAP) 102. The router 104 can be any of routers 104a-104d illustrated in FIG. 1. The router 104 can comprise a router processor and memory circuitry (PMC) 210 comprising a router processor 220 and a router memory 230. The DEAP 102 can comprise a DEAP processor and memory circuitry (PMC) 240 comprising a DEAP processor 250 and a DEAP memory 260. System 200 may further comprise the DHCP server 103.

The router processor 220 and the DEAP processor 250 are each configured to execute several functional modules in accordance with computer-readable instructions implemented on a non-transitory computer-readable storage medium such as the router memory 230 and the DEAP memory 260, respectively. Such functional modules may be realized by software stored in the memories 230 and 260 and executed by the respective processors 220 and 250. The router processor 220 can likewise implement a receiving module 222 and a routing module 224. The receiving module 222 is configured to receive communications from network entities, while the routing module 224 is configured to route communications to other network entities, such as another router 101, the computer 101, or the DEAP 102. The routing module 224 is also configured to reroute communications to the DEAP 102 in accordance with predefined rules, and optionally, route the communication back from the DEAP 102 to the destination in case no threat is detected. The router memory 230 may store Rules 232 including one or more predefined rules. The rules may be predefined in a preliminary stage, e.g., by an administrator of the network. After a rule is predefined, it can be stored in Rules 232 in one or more routers 104. Each rule may be associated with one or more IP addresses assigned in the network. A rule may also be associated with a range of IP addresses. Each rule may indicate a required security monitoring, such that the router 104 storing a predefined rule and receiving a communication with a destination or an initiating addresses associated with the stored rule, is configured to reroute the communication to a specified DEAP 102. In some examples, more than one DEAP 102 can be defined in a rule. Each rule may be updated, e.g. by the network administrator, as needed, and the updated rule may be stored in the relevant routers 104.

The DEAP processor 250 can likewise implement a DEAP communication module 252, a DEAP routing module 254, and the DEAP monitoring module 256. The DEAP communication module 252 is configured to receive communications from network entities, including those rerouted to DEAP 102 from their original destinations. The DEAP routing module 254 is configured to route communications back to the router 104, and/or optionally, to other network entities, to the intended destination or to other designated locations. The DEAP monitoring module 256 is configured to monitor communications by running one or more known security techniques, such as Deep Packet Inspection (DPI), signature engines, machine learning methods, behavioural analysis techniques, anomaly detection, intrusion detection systems (IDS), heuristic evaluation methods, or a combination thereof. The security methods can be stored within the DEAP memory 260, specifically in the security methods 262. The DEAP monitoring module 256 is further configured to execute any predefined policy enforcement logic to ensure that the rules or policies defined for securing the organization's network are correctly applied and adhered to. Policies 266 in DEAP memory 260 may store one or more policies which may be applied by the monitoring module 256. The stored policies may be determined based on threats detected in communications transmitted in the network 110, may pertain to a particular network entity, and may indicate on e.g., a particular action to be applied on future communication exchanged with the particular entities.

The DEAP monitoring module 256 is further configured to generate data indicative of the communication, such as a copy of the communication, packets, log PCAPs (Packet Capture, traffic recorded) etc. and to transmit it to other appliances to detect threats, such as to services in the cloud 105, or to apply a certain data collection logic for the purpose of monitoring for threats.

The DHCP server 103 is configured to assign IP addresses to network entities within the network 110. Additionally, during a configuration process or configuration update, the DHCP server 103 is set up to assign new destination addresses to selected network entities.

The DHCP server 103 can comprise a DHCP processor and memory circuitry (PMC) 270 comprising a DHCP processor 280 and a DHCP memory 290. The DHCP processor 280 is configured to execute several functional modules in accordance with computer-readable instructions implemented on a non-transitory computer-readable storage medium such as DHCP memory 290. Such functional modules may be realized by software stored in the memory 290 and executed by the processor 280.

The DHCP memory 290 is capable of storing a variety of IP addresses 292, which include numerous IP addresses assigned or assignable to network entities within network 110. Generally, these IP addresses fall within a predefined range or segment specific to the organization. Additionally, DHCP memory 290 may maintain designated segments 294 comprising multiple IP addresses designated for protected network entities. These particular IP addresses are typically assigned to network entities selected for traffic monitoring, and may be set aside for special use and are not typically employed by the organization for regular network operations. For instance, the IP address allocated to protected printer 106 might come from these designated segments 294. This categorization helps distinguish these specially assigned addresses and their corresponding network entities from other standard network entities within the organization. For example, while regular addresses in segment 292 might range from 0-50, the addresses in designated segments 294 could be set in a distinct segment, such as 100-110.

Each address within these designated segments 294 may be associated with one or more predefined rules (stored in Rules 232), which guide the rerouting of communications to one or more DEAPs 102. If the router 104 receives a communication directed to an address from these designated segments 294, it triggers a security monitoring rule requiring the communication to be rerouted to DEAP 102 for further analysis.

Those versed in the art will understand that the detection system 200, as depicted according to certain embodiments of the presently disclosed subject matter, can be expanded to include additional routers 104 and/or DEAPs 102. Furthermore, the detection system 200 might be configured with multiple setups, each consisting of one or more routers 104 and one or more DEAPs 102 that are operationally linked to the routers. To provide an example within network 110, consider an organization that spans several floors. The detection system 200 could feature various configurations across these floors, with each configuration involving one or more routers 104 and one or more DEAPs 102 working to identify threats in the communications occurring among network entities on each respective floor.

It should be noted that elements in FIGS. 1 and 2 can be made up of any combination of software and hardware and/or firmware that performs the functions as defined and explained herein. Elements in FIGS. 1 and 2 may be centralized in one location or dispersed over more than one location. For example, some computers 101 can reside outside the organization network 110, such that the communication discussed throughout this document can be exchanged between network entities within the organization network 110 as well as outside it. Also, some functionalities of DEAP processor 250, such as DEAP monitoring module 254, can be located at a different geographical location, remote from the other elements, such as in the cloud 105. Furthermore, in some examples of the presently disclosed subject matter, the detection system 200 may comprise fewer, more, and/or different elements than those shown in FIG. 2. For example, router 104, DEAP 102 and DHCP server 103 show several separate elements, each dedicated for executing certain functions of the system, however it will be clear to any person skilled in the art that the functionalities of the system can be otherwise divided. For instance, in an alternative system design, different functions assigned to receiving module 222 can be otherwise implemented by routing module 224. Various elements can be implemented as part of other computers in the system. Likewise, various elements described as distributed over different computers can be otherwise consolidated into a single computer device.

Those skilled in the art will also readily appreciate that the data repositories comprising the memories 230, 260 and 290 can be consolidated or divided differently; databases can be shared with other systems or can be provided by other systems, including third-party equipment. Specifically, rules 232 can be stored outside the router 104 and security methods 262 can be stored external to the system 200 such as in the cloud 105, and the system 200 can communicate with these storages, e.g. using a communication interface.

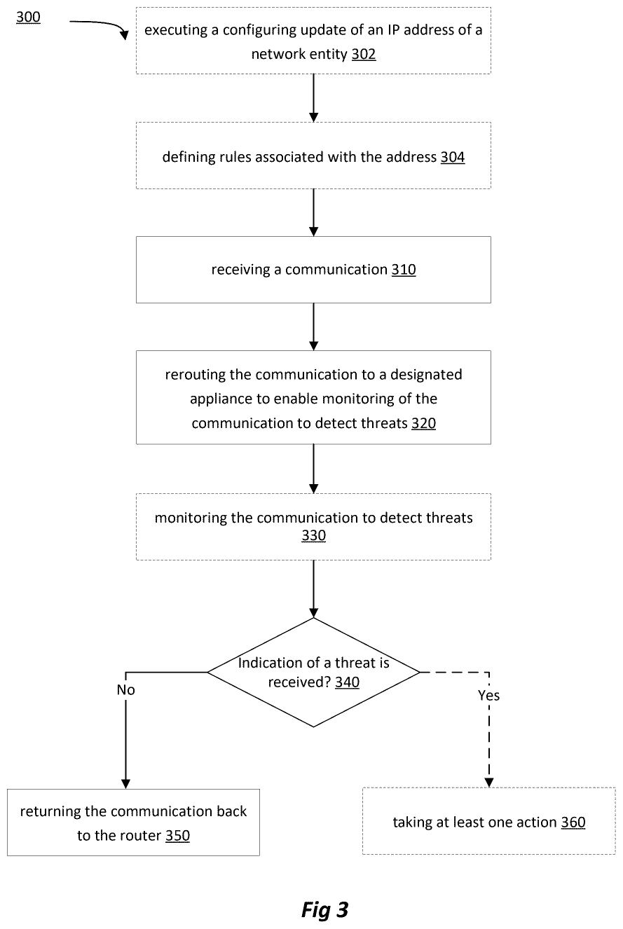

Referring to FIG. 3, there is illustrated a general flowchart of operations performed by the detection system 200, in accordance with certain embodiments of the presently disclosed subject matter. The following flowchart operations are described with reference to elements described in environment 100 and detection system 200. However, this is by no means binding, and the operations can be performed by elements other than those described herein.

According to the presently disclosed subject matter, there are instances where an organization opts to monitor traffic exchanged within network entities operating in network 110. It may choose to monitor all traffic flowing between every network entity within the network. However, often due to limitations in organizational resources, the organization might instead decide to monitor traffic specifically within a selected subset of network entities, such as traffic that is either initiated by or directed towards these chosen network entities within the designated subgroup.

The selection of a specific subgroup of network entities for monitoring, which includes one or more network entities, can be conducted manually by a network administrator, randomly, or based on a risk assessment of the network entities using known methodologies. Further details on optional selection of protected network entities, are described further below with respect to FIG. 5.

To facilitate the monitoring of traffic involving the selected subgroup of network entities, the IP addresses for these entities might be updated. This may be done at the DHCP server 103, by executing a configuration update process during which new IP addresses are assigned, possibly from designated segments 294, to the entities within the subgroup (block 301). Alongside the assignment of new IP addresses, one or more rules indicative of required security monitoring are defined, and are associated with each new IP address (block 304). In some examples, a single rule may be defined for all IP addresses of the network entities within the subgroup. The one or more rules may be stored in one or more routers 104, such as in rules 232 of each router, that is connected to the network entities in the subgroup. When a router 104a, which stores a predefined rule, receives a communication directed to a new IP address associated with this rule, it is configured to reroute the communication to the designated DEAP 102, e.g. through the tunnel 111. This configuration update of IP addresses along with the definition of the rules and storing them in the routers 104, are designed to streamline the rerouting of communications to the DEAP 102 instead of their intended destinations. Isolating the protected entities may further be achieved by assigning the new IP addresses from those segments which are not typically employed by the organization for regular network operations thus preventing from other network entities from communicating with the protected entities, and by establishing the tunnel 111 from the router 104a to the DEAP 102 thus enduring that the communication is rerouted to the DEAP 102.

To illustrate the above, consider the network 110 illustrated in FIG. 1, with the following original IP addresses for some of the network entities:

### Desktop Computers:

Computer 101a: 192.168.1.2
Computer 101b: 192.168.1.3

### Laptops:

Laptop 101c: 192.168.1.4

### Printers:

Printer 106: 192.168.1.10

### Servers:

Server 107: 192.168.1.20

### DEAP:

DEAP 102: 192.168.1.100

### Routers/Switches:

Main Router if such is defined e.g., router 104a: 192.168.1.1
Router 104b: 192.168.1.254

Assuming the organization managing network 110 decides to monitor communications involving three specific network entities, computers 101a and 101b, along with printer 106, which form a selected subgroup within the network. This selection might typically be made manually by an administrator of network 110. Consequently, any communications originating from or directed to these three entities should undergo monitoring, which involves rerouting the communications to one or more DEAPs 102 rather than directly to their intended destinations. The IP addresses for each of these network entities are configured and are updated to new ones at the DHCP server 103. Additionally, a one or more rules associated with each new IP address are predefined. This rule is indicative of a required security monitoring and directs that the communication is rerouted to the DEAP 102, rather than to any originally intended IP address listed in the communication.

The new IP addresses assigned to the three network entities can be as follows:
Computer 101a: 192.170.2.1/24
Computer 101b: 192.170.3.1/24
Printer 106: 192.170.4.1/24

One or more rules associated with above addresses can be defined as follows: “Any communication initiated by or directed towards IP addresses 192.170.1.1/16 should be sent to 192.168.1.100”, where 192.168.1.100 is the IP address of DEAP 102. In this particular example, the new IP addresses are allocated in the designated segment 100 used by the DEAP 102 and not typically used by the network 110, however, this should not be considered as limiting and the new IP addresses can be allocated in other segments, also such that are used by the organization.

For the purpose of illustration only, the following illustration pertains to a single DEAP 102 and one rule defines the entities within the subgroup. Those skilled in the art will readily appreciate that the teachings of the presently disclosed subject matter are, likewise, applicable to other configurations of organization networks and definitions of rules, where for example, a separate rule can be defined for each new IP address, and may specify a different DEAP 102 to reroute the communication to it. Alternatively, the rules can refer to a plurality of IP addresses under a single range or segment and can indicate that any addresses within that range or segment should be rerouted to a specific DEAP 102. Also, as mentioned above, in some implementations, several routers 104 may have tunnels to the DEAP 102, whether each router 104 handles a subnet comprising one or more entities including protected entities.

According to the presently disclosed subject matter, to detect a threat in a communication, the initiating network entity initiates the communication, and is then sent to a destination network entity. The communication may be directed towards a destination address of the destination network entity. In some cases, the communication may be received at the router 104a operatively connected to the initiating device (block 310), e.g. using receiving module 222.

Since the destination entity was selected as an entity in the subgroup of entities for which communication should be monitored, its IP address emerges from the a configuration update at DHCP server, assigning a new destination address to the destination network entity. The router 104a may retrieve from the communication the destination addresses of the destination entity, being the configured destination IP address. The router 104a can also retrieve from rules 232 any rule that was predefined and that is associated with the configured destination IP address. After retrieving a rule associated with the destination address, the router 104a can, in accordance with the rule, reroute the communication to the DEAP 102 (block 320), e.g. using routing module 224.

The DEAP 102 can enable monitoring of the communication to detect threats. Therefore, rerouting the communication to the DEAP 102 instead of to the destination enables the monitoring of communication. The DEAP 102 can receive the communication from the router 104a, e.g. using the DEAP 102 communication module 252.

In some examples, the DEAP 102 can monitor the communication to detect threats, e.g. using DEAP monitoring module 256 (block 330). Monitoring can be done by running one or more known security methods to detect threats, as stored in security methods 262, such as Deep Packet Inspection (DPI), signature engines, Machine learning methods, behavioral analysis techniques. In some examples, the DEAP 102 can perform the monitoring itself. In such examples, the DEAP 102 can contain the logic for performing the monitoring, while in some examples, the DEAP 102 can, alternatively or additionally, transmit the communication to a different appliance to monitor to detect threats such as a different designated network entity or can transmit data pertaining of the communication to the cloud 105 for monitoring. In some examples, the DEAP 102 can selectively monitor the communication to detect threats, e.g., focusing on only a subset of the communication that is exchanged. For example, the DEAP 102 may monitor communications exclusively during off-hours, under the assumption that communications sent during these times are more susceptible to scrutiny, given the expectation that they typically would not be transmitted outside of standard working hours. Alternatively, selectively monitoring of the communication can also be random, or can be based on other considerations, such as resource utilization, bandwidth costs or latency considerations.

Referring to the above example, the computer 101a initiates a printing task directed towards the destination printer 106 and transmits the printing task. The router 104a may receive the printing task from the computer 101a. As illustrated in FIG. 1, the direct path from the computer 101a to the printer 106, passes through: computer 101a, router 104a and printer 106. As mentioned, in the practical implementation of the network 110, there could be additional routers 104 along the road which ordinarily participate in routing communications according to the particular deployment of the network in the organization. Since the printer 106 was selected to be monitored, it was assigned with the new IP address of: 192.168.1.111. The router 104a receiving the printing task directed towards the address of 192.168.1.111, retrieves the rule of “Any communication initiated by or directed towards IP addresses 192.170.1.1/16 should be sent to 192.168.1.100”, from its storage, and can, in accordance with the rule, reroute the communication using tunnel 111 to 192.168.1.100 being the address of the DEAP 102. The DEAP 102 can run one or more security methods on the printing task to detect threats or can transmit a copy of the printing task to another appliance or service, e.g. residing in the cloud 105, to run the security methods or to gather data on communication exchanged with the printer 106.

Turning back to FIG. 3, the DEAP 102 can determine if an indication of a threat is identified (block 340), following either its direct monitoring and execution of security methods for threat detection or its forwarding of the communication to another appliance for threat identification, pending a report on any potential threat. If no indication of a threat is identified, the DEAP 102 returns the communication back to its original route to router 104a using the tunnel 111 (block 350). The router 104a can then route the communication towards its intended network destination, e.g., utilizing the routing module 224. T

In cases whether a potential threat is detected, then after receipt of an indication of a potential threat, the DEAP 102 may implement decisive measures to mitigate the identified threat, and to take one or more actions e.g., using DEAP monitoring module 256 (block 360). The actions that can be undertaken by DEAP 102 can be diverse and are strategically designed to address the threat directly at its source, either at the initiating or destination network entities, or by managing the communications flow between these entities. The range of actions includes, but is not limited to, block the communication, conditionally blocking one or more network entities from engaging in further communications, and enforcing pre-configured rules that may involve timing restrictions on communications, or a combination of actions. In some examples, one or more rules based on threats detected in the communication may be determined. The rules may pertain a particular network entity network entity, and may indicate e.g., on a particular action to be applied on future communication exchanged with the particular entity. Alternatively or additionally, the DEAP 102 can retrieve and apply policy enforcement logic based on one or more policies stored in policies 266 in DEAP memory 260, and e.g. block the communication. These measures are designed to facilitate control over network traffic, thereby eliminating the risk posed by the detected threat in real time, or near real-time, mainly effectively before the next sequence of network traffic occurs.

Referring back to the printing task example, if a threat is detected in the printing task, then DEAP 102 can block the printing task from reaching the final destination of printer 106.

Rerouting the communication to the DEAP 102, while enabling it to monitor the communication and take an action if an indication of a potential threat is received, is advantageous, as the proactive response approach facilitates the security of network communications in a manner that is both effective and timely. One significant advantage of this approach is its direct intervention in the traffic flow, allowing for an immediate response to security threats, while acting as a man-in-the-middle without changing the structure of the network (with the exclusion of changing the IP addresses of the protected entities). This capability not only enhances the system's efficiency in threat mitigation but also ensures that control over network communications is maintained within the organizational infrastructure, allowing for a seamless and secure network operation. Furthermore, the approach that actions are applied directly to the communication itself by the DEAP 102 contributes to ensuring that only safe, verified communications are allowed to proceed to their intended destinations. Another advantage is that if no threat is detected, this approach thereby facilitates the transparent transmission of communications between network entities within the network, while simultaneously allowing for the monitoring of these communications. The communication is returned back to its original route to reach the destination, without violating any predefined general policies applied on the network, such as firewall policies, etc.

For purpose of illustration only, the description refers the DEAP 102 as being a separate entity than the router 104a or any other router 104, however, those skilled in the art will readily appreciate that the teachings of the presently disclosed subject matter are, likewise, applicable to cases where the router 104 and the DEAP 102 are identical and form the same entity. In such cases, the DEAP 102 can form the default gateway of some network devices, in particular those which are selected to be monitored. Alternatively, or additionally, the DEAP 102 can include routing capabilities and in case no threat is identified, can route the communication to the destination entity.

Also, for purpose of illustration only, the description illustrated communication exchanged between an initiating network entity and the destination network entity, where both entities belong to the same organization network 110. However, those skilled in the art will readily appreciate that the teachings of the presently disclosed subject matter are, likewise, applicable to cases where communication is exchanged between network entities within the network 110 and network entities outside it.

Moreover, the description illustrated monitoring communication based on rules associated with the destination address. In the above example, the printing task was monitored since the printer 106 was selected to be monitored, and hence, rules were associated with the printer's IP address. However, those skilled in the art will readily appreciate that the teachings of the presently disclosed subject matter are, likewise, applicable to cases where traffic is monitored due to rules associated with IP addresses of initiating network entities when such belong to the network 110.

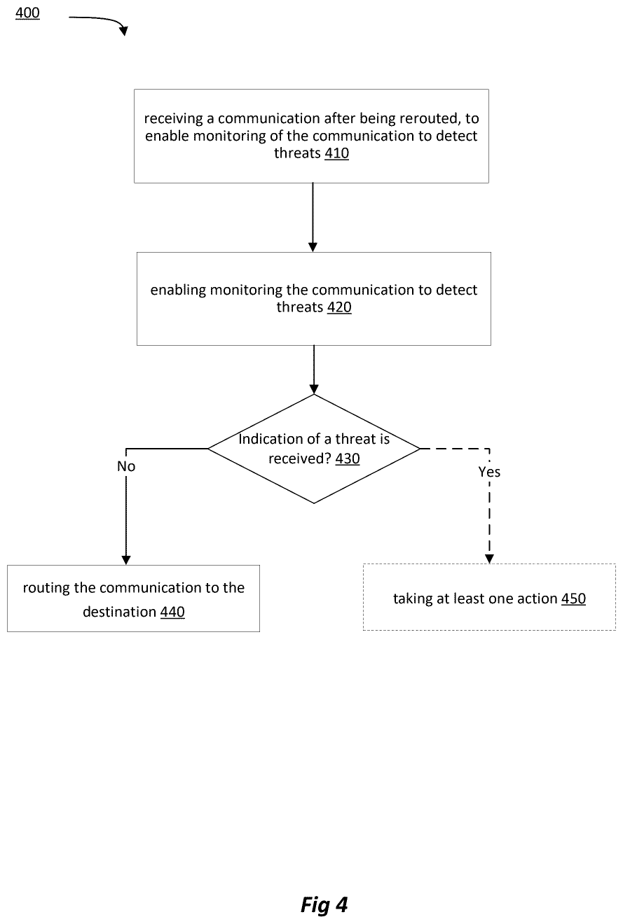

Reference is illustrated to FIG. 4, illustrating a generalized flowchart of operations performed by the detection system 200, in accordance with certain embodiments of the presently disclosed subject matter. The operations described in FIG. 4 pertain monitoring communication based on the initiating network entity as a protected entity rather than based on the destination network entity. However, as mentioned below, particular operations and functionality of the network entities may be similar to those described above.

As detailed above, the IP addresses of selected network entities for which the communication exchanged with these network entities should be monitored, may be configured in a configuration update process and new IP addresses may be assigned to them. In addition, rules associated with the addresses of the selected network entities, and indicative of a required security monitoring, may also predefined, and may be stored in the relevant routers operatively connected to the selected network entities. Yet, in some cases, the DEAP 1032 may serve as the default gateway of the protected entities, as illustrated by the dashed connection 113 in FIG. 1 between the computer 101b and the DEAP 102. Defining the DEAP 102 as the default gateway for the protected entities ensure that communications initiated by protected entities are directly received by DEAP 102. Alternatively, in other scenarios, the DEAP 102 may be connected through a router, such as router 104a, to the protected entities, and may receive the communications initiated by them. In both scenarios, the communications are rerouted to DEAP 102 from the initiating network entity, according to a predefined rule associated with the initiating address of the network entity. This rerouting occurs either because DEAP 102 is designated as a default gateway based on a predefined rule or because router 104a directs the communication to DEAP 102 following a rule associated with the initiating address of the protected entity. The predefined rule is indicative of a required security monitoring and directs the communication to DEAP 102 for this purpose, where the DEAP 102 enables the monitoring of the communication.

Assuming cases where a protected entity, having a new IP address initiates a new communication. In some cases, the DEAP 102 may receive the communication initiated and transmitted from the initiating entity. This reception may be facilitated by the DEAP communication module 252 (block 410).

After receipt of communication, the DEAP 102 enables monitoring of the received communication to detect threats (block 420). In a similar manner to that described above, the DEAP 102 may directly monitor the communication, e.g. using DEAP monitoring module 256 by running one or more known security methods to detect threats, as stored in security methods 262. In some examples, alternatively or additionally, the DEAP 102 can transmit data indicative of the communication to a different appliance to monitor to detect threats. As described above, in some examples, the DEAP 102 can selectively monitor the communication, e.g., focusing on only a subset of the communication that is exchanged.

As described above, the DEAP 102 can determine if an indication of a threat is identified (block 430). If no indication of a threat is identified, the DEAP 102 proceeds to route the communication towards its intended network destination, e.g., utilizing the DEAP routing module 254 (block 440). In cases where the DEAP 102 is not the default gateway and the communication was rerouted to it in accordance with a respective rule, then if no indication of a threat is identified, the DEAP 102 returns the communication back to its original route, e.g., to the router that rerouted the communication towards it. On the other hand, upon receiving an indication of a potential threat, the DEAP 102 may implement decisive measures to mitigate the identified threat, and to take one or more actions (block 450), e.g., selected from the actions described above with respect to block 360.

For purpose of illustration only, the description refers one communication transmitted from an initiating network entity and directed towards a destination network entity, however, those skilled in the art will readily appreciate that the teachings of the presently disclosed subject matter are, likewise, applicable to a plurality of communications exchanged within the network, where the method for detecting threats is implemented on at least one of the exchanged communications. The method can selectively be implemented on the communications, either since the initiating network entity is a protected entity selected for monitoring communication initiated by it, and/or since the destination network entity is a protected entity selected for monitoring communication that are directed towards it. Alternatively, the method can be implemented on a subgroup of selected network entities for which the IP addresses are configured in a configuration update and associated rules are defined.

For purpose of illustration only, the above description is provided for detecting a threat in a communication exchanged within the organization. Those skilled in the art will readily appreciate that the teachings of the presently disclosed subject matter are, likewise, applicable to enhancing resilience and continuity in enterprise communications. In the event of a failure in areas in organization's network, such as in a secured environment which could compromise the security and functionality of the network, the above description may facilitate the continuity of routing communication by assigning new IP addresses to some network entities and defining rules pertaining to these IP addresses, which defining rerouting the communication to a designated appliance such as the DEAP 102 described above. In a similar manner to that described throughout the description, based on the new IP addresses and the rules, communication can be rerouted to pass through the DEAP 102, and may be routed from the DEAP 102 to the final destination, thus circumventing the failure in the particular area.

In some examples, prior to applying the operations described with respect to FIGS. 3 and 4, in which communication is rerouted to the DEAP 102 on its way to the destination, the organization operating organization network 110 may wish to select one or more network entities within network 110 to apply the rerouting of communications involving the selected entities.

Following is a description pertaining to optional selection of one or more protected network entities from network 110, on which the teaching of the operations described with reference to FIGS. 3 and 4 may be performed. Full details of the optional selection are disclosed in U.S. application Ser. No. 18/655,438, filed on May 6, 2024, incorporated herein by reference.

To illustrate the selection, reference is made to FIG. 5 illustrating a general flowchart of operations performed by the monitoring system 120 comprised in the network 110, in accordance with certain embodiments of the presently disclosed subject matter. Although the monitoring system 120 is illustrated as comprised in the network 110, those versed in the art would realize that it can be located outside the network 110 and can communicate with the network 110 to provide input to the network 110.

The monitoring system (MS) 120 comprises an MS processor and memory circuitry (MS PMC) 510 comprising an MS processor 520 and an MS memory 530. The MS processor 520 is configured to execute several functional modules in accordance with computer-readable instructions implemented on a non-transitory computer-readable storage medium such as MS memory 530. Such functional modules may be realized by software stored in memory and executed by the MS processor 520. The MS processor 520 can implement a risk assessment module 522, a selection module 524, a determining module 526 and an applying module 528.

The risk assessment module 522 is configured to obtain the risk scores of entities within the network 110. This may be achieved by calculating risk scores directly e.g. using known methods, or by obtaining them from external tools designed for assessing the risk scores of network entities. Additionally, risk assessment module 522 is configured to receive new indications of potential risk pertaining to one or more network entities, such as those received from a firewall system operating within the network 110, or an external threat intelligence system, from analyzing the recent network behavior of those entities.

The selection module 224 is configured to select at least one group of network entities based on the risk scores obtained from the risk assessment module 522. In addition, in some examples, the selection module 224 is configured to classify the network entities into multiple groups based on their respective calculated risk scores. The determining module 526 is configured to determine the appropriate type of traffic data collection method for each group of network entities. The determining module 526 can select the method that is most appropriate for the specific security requirements and risk profiles of each group. One of the methods may include the operations described with reference to FIGS. 3 and 4 above of rerouting the communication to the DEAP 102 so the DEAP 102 enables the monitoring of the communication to detect threats. For the purpose of the disclosure of selection of a group of entities to apply a type of data collection methods, then rerouting the communication to the DEAP 102 to enable monitoring of the communication may be considered as one type of data collection method.

Finally, the applying module 528 is configured to apply specific security methods based on the traffic data collection methods determined by the determining module 526, including executing the operations illustrated with respect to FIGS. 3 and 4. The MS memory 530 may store calculated risk scores 532 including risk assessment scores of entities within the network, as obtained from the risk assessment module 522. The MS memory 530 may also store determination criteria 534 including one or more criteria comprising at least risk scores, types of network entities, constraints of an organization operating the network and network resources.

Elements in FIG. 5 can be made up of any combination of software and hardware and/or firmware that performs the functions as defined and explained herein. Elements in FIG. 5 may be centralized in one location or dispersed over more than one location. For example, each one of elements 522, 524, 526 and 528 can be located at a different geographical location, remote from the other elements. Furthermore, in some examples of the presently disclosed subject matter, the monitoring system 120 may comprise fewer, more, and/or different elements than those shown in FIG. 5. For example, elements 524 and 526 form as separate elements, each dedicated for executing certain functions of the system, however it will be clear to any person skilled in the art that the functionalities of the system can be otherwise divided. For instance, in an alternative system-design, different functions assigned to applying module 528 can be otherwise implemented by determining module 526. Likewise, various elements described as distributed over different computers can be otherwise consolidated into a single computer device.

Those skilled in the art will also readily appreciate that the MS memory 530 can be consolidated or divided differently; databases can be shared with other systems or can be provided by other systems, including third-party equipment. Specifically, MS memory 530 can be stored external to the system 120, and the system 120 can communicate with the MS memory 530, e.g. using a communication interface (not shown).

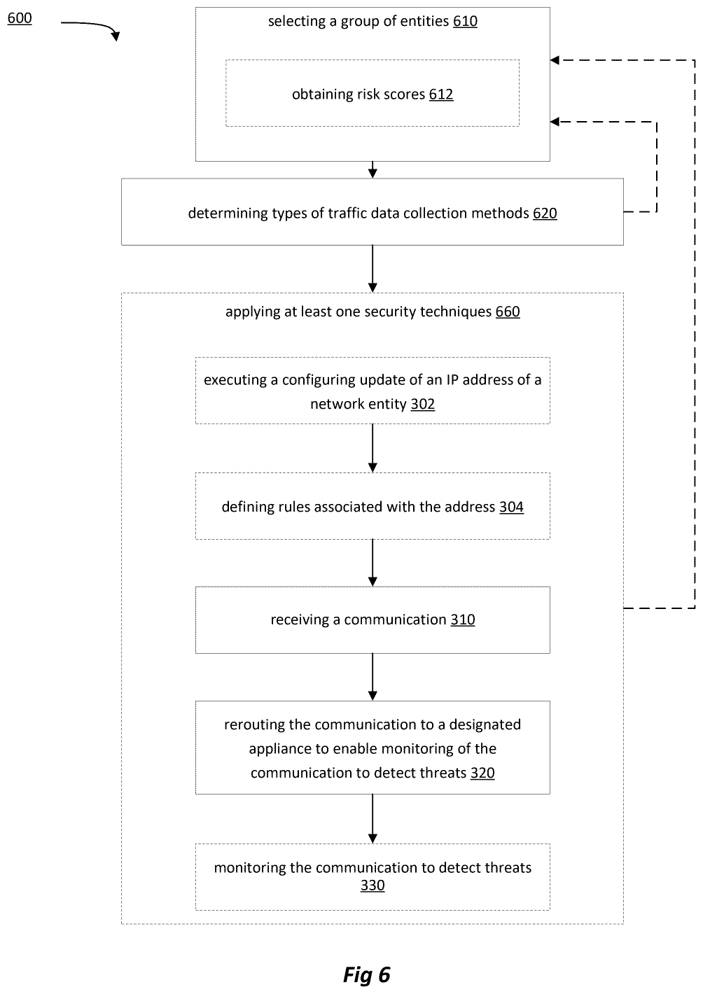

Referring to FIG. 6, there is illustrated a generalized flow chart 600 of operations performed by the monitoring system 120, in accordance with certain embodiments of the presently disclosed subject matter. The following flowchart operations are described with reference to elements of monitoring system 120. However, it is important to note that these operations can also be executed by alternative components not explicitly described herein.

As depicted in FIG. 6, in order to facilitate detection of threats in a network, a computer-implemented method is described. In some cases, the method initiates by selecting at least one group of network entities in the network 110, based on a respective calculated risk score (block 610). The selection can be performed by the selection module 524. In some examples, the selection module 524 can classify the network entities into multiple groups based on their respective calculated risk scores. For the purpose of this disclosure, the selecting of at least one group can comprise classifying the plurality of network entities. Classification can be done e.g. using known methods for classifying entities based on risk parameters.

In order to select the entities, risk scores of the entities may be obtained (block 612), e.g., by risk assessment module 522. The risk assessment module 522 can obtain the risk scores of the entities by calculating risk scores directly e.g. using known methods, or by obtaining them from external tools designed for assessing the risk scores of network entities. Additionally, risk assessment module 522 can receive new indications of potential risk pertaining to one or more network entities, such as those received from a firewall system operating within the network 110 and may calculate risk scores for the network entities considering also the indication, e.g. using known methods. In some examples, risk scores are calculated for all network entities, while in some other examples, risk scores are calculated only for a subgroup of the network entities. For example, manual or automatic exclusion of low-risk network entities or non-functional entities, from risk assessment can be made. Accordingly, these low-risk network entities or non-functional entities can optionally be excluded from the selection or the classification process.

Calculating risk scores of network entities can be performed using known methods of risk assessment, such as active scanning of network entities and monitoring their responses, assessing the risk scores based on various parameters such as the types of the network entities, the history of traffic exchanged with the network entities, history of previous attacks, history of breaches of network entities, vulnerability scanning, configuration scanning, asset type classification, or a combination of the parameters.

After the risk scores are calculated, the selection module 524 can select one or more network entities based on the respective calculated risk score of the network entities. Alternatively, or additionally, the selection module 524 can then classify the network entities into one or more groups. The method of selection or classification may vary depending on several factors. In some instances, the organization may decide in advance to group the entities into a predetermined number of groups, based on historical data or organizational policy. In other scenarios, the distribution of risk scores among the network entities is analyzed, and groups are formed dynamically to ensure that entities with similar risk profiles are grouped together. This allows for a more tailored approach to applying security measures, where the nature of the threat and the vulnerability of the entities are more closely aligned. Furthermore, the method of grouping can also be influenced by the available resources, particularly the different methods of traffic data collection available. The organization may assess its capability to monitor and manage network traffic and then decide on the grouping strategy that best utilizes these resources. For example, if intensive data collection methods like DPI are limited in capacity, higher-risk groups may be smaller to ensure that these resources are not overwhelmed, while lower-risk groups might be larger and subjected to less intensive monitoring techniques. Adopting a flexible approach of selection is advantageous as the organization can optimize its security infrastructure to ensure that resources are allocated efficiently and that the security measures are commensurate with the assessed risk levels of the network entities.

Following the selection of entities to groups, the process proceeds to determine at least one respective type of traffic data collection method appropriate for traffic exchanged with the network entities in the one or more groups, optionally, in each group (block 620). Determining the suitable type of traffic data collection method for at least one group can facilitate the application of one or more security techniques to detect threats using data collected according to the respective type. The type of traffic data collection method employed may incorporate one or more advanced security techniques. These techniques can include Deep Packet Inspection (DPI), signature engines, machine learning methods, behavioral analysis techniques, anomaly detection, intrusion detection systems (IDS), and heuristic evaluation methods. Additionally, a combination of these techniques may also be used, depending on the specific security needs and the risk profile of the network entities being monitored. One of the types of traffic data collection method may include executing the operations described with reference to FIGS. 3 and 4 above, e.g. by the router 104, including rerouting the communication to the DEAP 102 to enable monitoring of the communication.

In some examples, determining of the suitable type of traffic data collection method can be according to determination criteria. The determination criteria can comprise a plurality of criteria such as the risk score, characteristics of the network entity including its type and the amount of traffic sent by the entity, constraints of an organization operating the network, network resources and a combination of the criteria. For example, one criterion can be the amount of traffic an entity is sending. For example, a very small amount is not of interest to track, whereas a too large amount (video streaming, for instance) may exhaust the network resources dedicated for monitoring. These criteria may influence on the determination if the rerouting of the communication to the DEAP 102 to enable monitoring is feasible and desirable.

Determining at least one type of traffic data collection method according to the determination criteria can comprise at least one of the criteria.

After determining the types of traffic data collection methods, the process can continue to apply at least one security method based on the determined type to detect threats using data collected according to the respective type (block 630). Applying a security method can include execute the operations described with reference to FIGS. 3 and 4, in particular, execute operations 302, 304 if not already performed, to enable the router 104 to execute the operations 310 and 320 upon receipt of communication exchanged with the selected entities. As illustrated with reference to FIG. 3, in case no indication of a threat is identified, the communication is rerouted to the destination network entity, whereas in case a threat is detected, then one or more actions can be taken.

The purpose of applying security techniques is to detect potential threats in real-time in communication exchanged within entities in groups. Some examples of security methods include anomaly detection, behavioral analysis and signature-based detection.

In some examples, the steps of selecting network entities (block 610) and determining the type of traffic data collection method (block 620) can be repeated, e.g., periodically, to redetermine the most suitable traffic data collection method. This repetition may involve re-obtaining risk scores (block 612), where updated risk scores are acquired by the risk assessment module 522 through newly performed calculations for the network entities. Based on these updated risk scores, new groups of entities can be selected and/or classified, and a different traffic data collection method can be redetermined for the new groups, as described above according to the determination criteria. The advantage of reassessing the methods based on updated risk scores lies in the ability to review and adjust the previous monitoring strategy implemented by monitoring system 120. This adjustment is advantageous as it accommodates dynamic changes in the risk landscape of network 110, ensuring that the monitoring strategy remains effective and relevant despite changes occurring in the risk scores of entities. As a result of selecting new entities, optionally, classifying into new groups and redetermining the types of traffic data collection methods, different security techniques can be applied for the entities.

Repeating the steps of selecting network entities (block 610) and determining (block 620) and repeating the steps of selecting (block 610), determining (block 620) and applying security techniques (block 660) may occur at regular intervals, such as hourly, daily, or weekly, or may be triggered on-demand in real time, to reassess and redetermine the appropriate traffic data collection method. For instance, the initiation of this process might occur in response to the receipt of an unexpected threat indication by the risk assessment module 222, triggering a reassessment and redetermination of the suitable traffic data collection method. The repetition of these steps can be limited to a specific subgroup of entities, maintaining the existing grouping for those entities for which reassessment is not deemed necessary.

In some examples, redetermining of the appropriate type of traffic data collection method includes selecting a different type of traffic data collection method for network entities based on a change in one or more criteria comprised in the determination criteria. For example, in case the available network resources are reduced or since the risk score of an entity is increased, then a different type of traffic data collection method should be applied on the entities of the group of entities. Redetermining of the appropriate type can be for a particular network entity, e.g. since it was now classified to a different group, or to the entire group, e.g. since the availability of the network resources has been changed.

Assume, for instance, that printer 106 was initially classified into a group with a low-risk profile. Accordingly, a shallow data extraction method that involves analyzing only the metadata or headers of communications was determined to be sufficient for exchanges involving this printer. However, if a breach indication is received concerning printer 106, the situation changes significantly, and the monitoring strategy should be promptly adjusted. Upon receiving this threat indication, the risk assessment module 522 triggers a re-evaluation of the monitoring strategy. This indication triggers the repetition of both the selection and determination steps previously outlined. Consequently, the classification of printer 106 may be revised, moving it from a low-risk to a higher-risk group based on the new threat information. Accordingly, the type of traffic data collection method is also reevaluated and adjusted from a shallow method to a more comprehensive one, such as executing the steps of operations 302-330. This change ensures that the monitoring strategy is dynamically aligned with the current risk conditions and that the security measures are sufficiently robust to address and mitigate the newly identified threat on printer 106 and the network 110, effectively, in real time.

In cases where the network entities have been classified into a plurality of groups, based on their respective calculated risk scores, different types of traffic data collection methods can be determined to fall into two distinct groups. Each data collection method may be selected based on distinct characteristics that are specific to each group, ensuring that the approach is optimally aligned with the unique security requirements and risk profiles of these groups.

Further refining the process, the determination of each traffic data collection method may be guided by the determination criteria as described above including e.g., the risk scores of the entities, the types of the network entities, constraints imposed by the organization operating the network, the available network resources, or a combination thereof.

It is noted that the teachings of the presently disclosed subject matter are not bound by the flowchart illustrated in FIGS. 3, 4 and 6, the illustrated operations can occur out of the illustrated order. For example, operations <302> and <304>, and in some instances, operations <302> and <304>, and operations <610>, <620> and <630> (e.g. in cases some configuration were already made in the detection system 200) shown in succession can be executed substantially concurrently or in the reverse order.

In various examples of the presently disclosed subject matter, fewer, more, and/or different stages than those shown in FIGS. 3, 4 and 6 may be executed. In embodiments of the presently disclosed subject matter, one or more stages illustrated in the figures may be executed in a different order, and/or one or more groups of stages may be executed simultaneously.

It is noted that, as is well known in the art, systems operating in real time may experience some delay between the onset of a command and its execution, due to various reasons such as processing time and/or network communication delay. The term real-time as used herein is meant to include near real-time i.e., operation in systems that may experience some internal delays.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the concept upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

Those skilled in the art will readily appreciate that various modifications and changes can be applied to the embodiments of the invention as hereinbefore described without departing from its scope, defined by the appended claims.

1. A computer-implemented method for detecting a threat in a communication sent from an initiating network entity to a destination network entity, the method comprising:
by a processor of a router:
receiving, the communication, wherein the communication is directed from an initiating address of an initiating network entity to a destination address of a destination network entity;
in accordance with a predefined rule associated with at least one of the initiating address or the destination address, rerouting the communication to a designated appliance (DEAP), to enable monitoring of the communication to detect threats, wherein the predefined rule is indicative of a required security monitoring of communications involving at least one of the initiating network entity or the destination network entity; and
in case no indication of a threat is identified, routing the communication to the destination network entity.

2. The method of claim 1, wherein initiating network entity and the destination network entity belong to the same organization network.

3. The method of claim 1, wherein the address of at least one of the initiating network entity or the destination network entity emerges from configuration update at a Dynamic Host Configuration Protocol (DHCP) server, assigning a new address to respective network entity, thereby facilitating rerouting of communications involving the respective network entity based on the associated predefined rule.

4. The method of claim 3, wherein the address from the configuration update is allocated in a designated segment of addresses, wherein addresses in the designated segment are isolated such that communications directed to or from addresses in the designated segment are associated with one or more predefined rules pertaining to rerouting of communications to at least one DEAP.

5. The method of claim 1, wherein the method further comprises, by a processor of the DEAP:
monitoring the communication to detect threats.

6. The method of claim 5, wherein the method further comprises by the processor of the DEAP:
transmitting data indicative of the communication to a different appliance to monitor.

7. The method of claim 5, wherein the method further comprises by the processor of the DEAP:
enabling selective monitoring of the communication to detect threats.

8. The method of claim 1 further comprising:
receiving an indication of a potential threat.

9. The method of claim 8 further comprising:
taking at least one action.

10. The method of claim 9, wherein the at least one action can be applied on the initiating and destination network entities and/or on communications flow between the network entities and can be selected from a group comprising: blocking transmission of future communications, conditional blocking one or more of the network entities from engaging in further communications, enforcing pre-configured rules that involve timing restrictions on communications applying, or a combination thereof.

11. The method of claim 9, wherein the at least one action is applied on the communications themselves.

12. The method of claim 1, wherein prior to routing the communication, the method further comprising:
receiving the communication back from the DEAP.

13. The method of claim 1, wherein the DEAP is either the initiating network entity or the destination network entity, and wherein the predefined rule involves monitoring communications to or from the DEAP to detect threats.

14. A system comprising a plurality of network entities configured to exchange communications with each other, wherein the method of claim 1 is selectively implemented on at least one of the communications.

15. The system of claim 14, wherein the method of claim 1 is selectively implemented on communications exchanged between a subgroup of the network entities.

16. The system of claim 15, wherein each address of each network entity in the subgroup emerges from a configuration update at a Dynamic Host Configuration Protocol (DHCP) server, assigning a new address to the respective network entity, thereby facilitating rerouting of communications involving the respective network to the DEAP, based on the associated predefined rule.

17. The system of claim 16, wherein the addresses from the configuration update are allocated in at least one designated segment of addresses, and are isolated such that communications directed to or from addresses in the designated segment are associated with one or more predefined rules, pertaining to rerouting of communications to at least one DEAP.

18. A computer system for detecting a threat in a communication sent from an initiating network entity to a destination network entity, the system comprising a processing circuitry comprising at least one processor and computer memory, the processing circuitry being configured to execute a method as defined by claim 1.

19. A non-transitory computer readable storage medium tangibly embodying a program of instructions that, when executed by a computer, cause the computer to perform a method for detecting a threat in a communication sent from an initiating network entity to a destination network entity as defined by claim 1.

20. A computer-implemented system for detecting a threat in a communication exchanged between network entities, the system comprising:
a router configured to:
receiving, the communication, wherein the communication is directed from an initiating address of an initiating network entity to a destination address of a destination network entity; and
in accordance with a predefined rule associated with at least one of the initiating address or the destination address, rerouting the communication to a designated appliance (DEAP), wherein the predefined rule is indicative of a required security monitoring of communications involving at least one of the initiating network entity or the destination network entity;
the DEAP, in communication with the router, is configured to:
receive the communication from the router;
enable monitoring of the of the communication to detect threats and communicate a suitable indication to the router; and
wherein in case no indication of a threat is identified, the router is further configured to:
routing the communication to the destination network entity.

21. The system of claim 20, further comprising:
a Dynamic Host Configuration Protocol (DHCP) server configured for implementing a configuration update process that assigns new address to network entities to facilitate rerouting of communications involving the respective network entities based on associated predefined rules.

22. The system of claim 21, wherein the DEAP is further configured to:
monitor the communication to detect threats.

23. The system of claim 21, wherein the DEAP is further configured to:
transmit the communication to a different appliance to monitor to detect threats.

24. The system of claim 21, wherein the DEAP is further configured to:
enable selective monitoring of the communication to detect threats.

25. The system of claim 22, wherein in case of an indication of a potential threat, the DEAP is further configured to:
take at least one action.

26. A computer-implemented method for facilitating detection of threats in a network, comprising:
selecting at least one group of network entities, based on a respective calculated risk score of the one or more network entities;
for network entities within the selected group, determining at least one respective type of traffic data collection method appropriate for traffic exchanged with these network entities, thereby facilitating the application of one or more security techniques to detect threats using data collected according to the respective type; and
applying at least one security method based on the determined type by executing operations by a processor of a router on communication sent from an initiating network entity to a destination network entity, wherein at least one of the initiating network entity and the destination network entity are comprised within the selected group:
receiving, the communication, wherein the communication is directed from an initiating address of an initiating network entity to a destination address of a destination network entity;
in accordance with a predefined rule associated with at least one of the initiating address or the destination address, rerouting the communication to a designated appliance (DEAP), to enable monitoring of the communication to detect threats, wherein the predefined rule is indicative of a required security monitoring of communications involving at least one of the initiating network entity or the destination network entity; and
in case no indication of a threat is identified, routing the communication to the destination network entity.
